(19) United States
(12) Patent Application Publication
(10) Pub. No.: US 2025/0285048 A1
(43) Pub. Date: Sep. 11, 2025

(54) MODELING AGENT WORK ATTRIBUTES FOR IMPROVED AGENT SCHEDULING IN A CONTACT CENTER

(71) Applicant: GENESYS CLOUD SERVICES, INC., MENLO PARK, CA (US)

(72) Inventors: CLIFF W. BELL, MENLO PARK, CA (US); DANIEL STEWART STOOPS, MENLO PARK, CA (US)

(73) Assignee: GENESYS CLOUD SERVICES, INC., MENLO PARK, CA (US)

(21) Appl. No.: 18/597,521

(22) Filed: Mar. 6, 2024

(51) Int. Cl. G06Q 10/0631; G06Q 10/0639

(52) U.S. Cl. CPC G06Q 10/063116; G06Q 10/06393; G06Q 10/06395

(57) ABSTRACT

A method that includes an automated modeling process having the steps of: receiving shift data describing evaluation shifts worked by the agent and determining therefrom values for shift parameters; monitoring performance of the agent during each of the evaluation shifts in relation to an adherence metric and determining therefrom a score associated with the adherence metric for each; creating a training dataset that includes training samples for respective ones of the evaluation shifts, each training sample including the determined values of the shift parameters paired with the score achieved in relation to the adherence metric; and using the training dataset to train a work attributes model for the agent, the work attributes model configured to identify a key value for a key shift parameter that statistically correlates with the agent achieving a better score in relation to the adherence metric.

### BACKGROUND

The present invention generally relates to customer relations services and customer relations management via contact centers and associated cloud-based systems. More particularly, but not by way of limitation, the present invention pertains to an automated tool for modeling and predicting agent work attributes for generating individualized work schedules that promote improved performance, particularly in relation to adherence metrics.

### BRIEF DESCRIPTION OF THE INVENTION

The present invention includes a computer-implemented method in a contact center related to modeling work attributes of agents to generate individualized work schedules for the agents that promote improved performance relative to an adherence metric. The method may include the steps of: generating, via an automated modeling process, a work attributes model for an agent and identifying therewith a key value for a key shift parameter; transmitting, in association with the agent, the identified key value for the key shift parameter to an automated agent scheduling application; and generating, via the automated agent scheduling application, a work schedule for the agent covering future shifts that takes into account the identified key value for the key shift parameter. The automated modeling process may include: receiving shift data describing evaluation shifts worked by the agent and determining therefrom values for shift parameters associated with each of the evaluation shifts; monitoring performance of the agent during each of the evaluation shifts in relation to the adherence metric and determining therefrom a score associated with the adherence metric for each of the evaluation shifts; creating a training dataset that includes training samples for respective ones of the evaluation shifts, wherein, each training sample includes the determined values of the shift parameters paired with the score achieved in relation to the adherence metric for one of the evaluation shifts; and using the training dataset to train the work attributes model for the agent, the work attributes model configured to at least identify a key value for a key shift parameter of the shift parameters that statistically correlates with the agent achieving a better score in relation to the adherence metric.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a simplified flow diagram demonstrating functionality of a machine learning model in accordance with embodiments of the present invention;

FIG. 4 is a schematic representation of a machine learning model in accordance with exemplary operation of embodiments of the present invention;

FIG. 5 is an exemplary method of the present invention in accordance with an embodiment;

FIG. 6 is another exemplary method of the present invention in accordance with an embodiment; and

FIG. 7 is a schematic representation of a process flow diagram in accordance with an alternative embodiment of the present invention.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

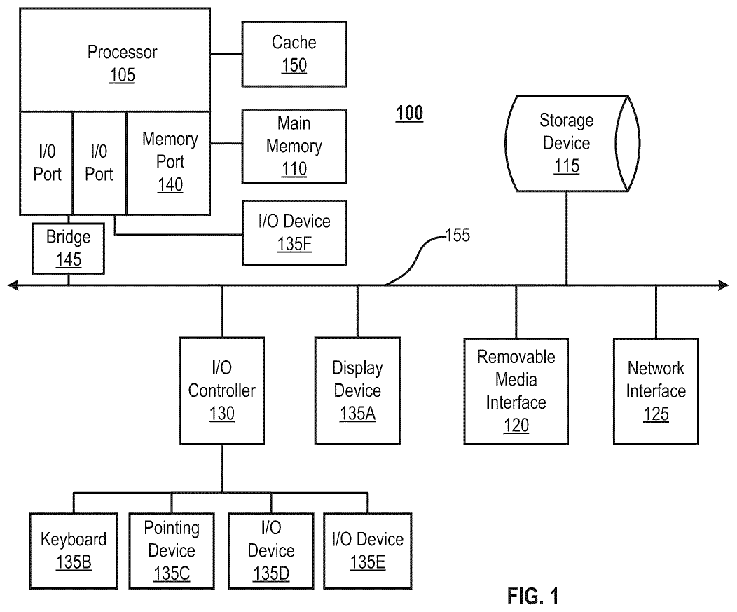

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

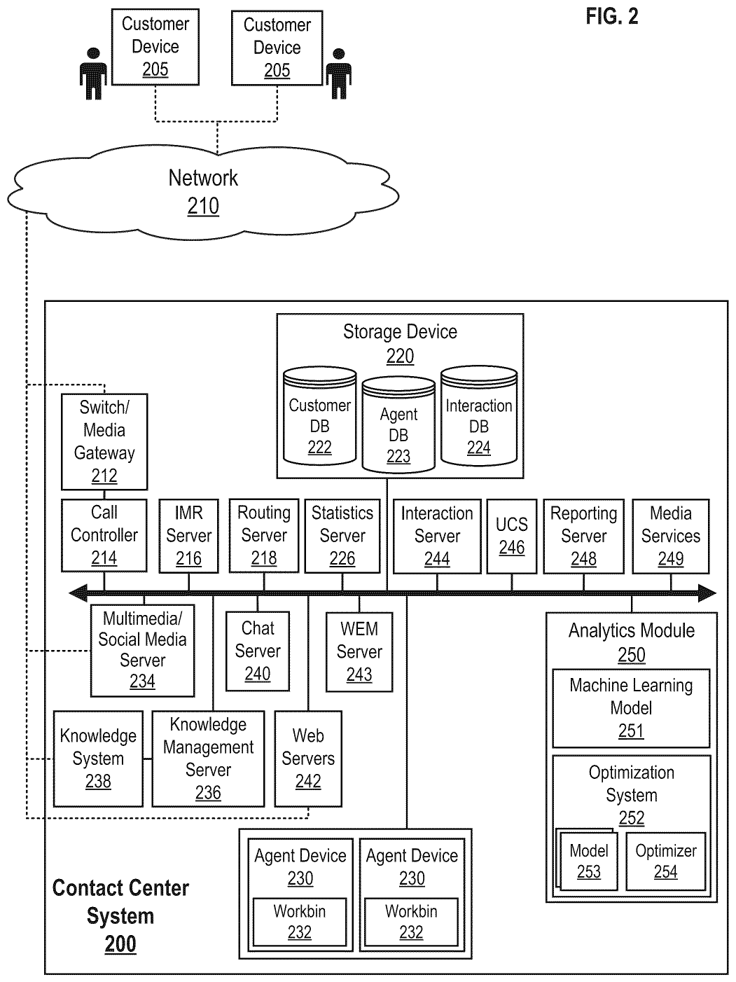

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VOIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more machine learning models, which may be based on neural networks. In certain embodiments, the machine learning model 251 is configured as a deep learning model, which is a type of machine learning based on neural networks in which multiple layers of processing are used to extract progressively higher level features from data. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Machine Learning Models

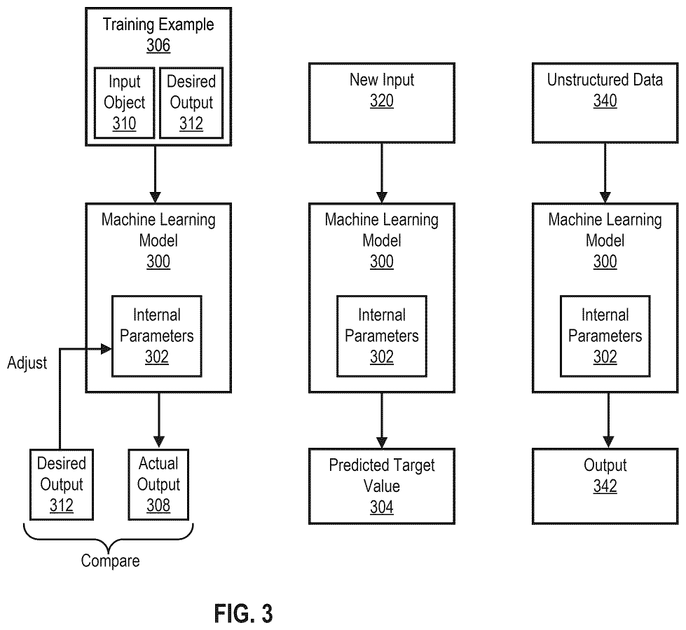

FIG. 3 illustrates an exemplary machine learning model 300, which may be included in one or more of the embodiments of the present invention. The machine learning model 300 may be a component, module, computer program, system, or algorithm. As described below, some embodiments herein use machine learning for providing predictive analytics for application in a contact center. Machine learning model 300 may be used as the model to power those embodiments. Machine learning model 300 is trained with training data samples 306, which may include an input object 310 and a desired output value 312. For example, the input object 310 and desired object value 312 may be tensors. A tensor is a matrix of n dimensions where n may be any of 0 (a constant), 1 (an array), 2 (a 2D matrix), 3, 4, or more.

The machine learning model 300 has internal parameters that determine its decision boundary and that determine the output that the machine learning model 300 produces. After each training iteration, which includes inputting the input object 310 of a training data sample into the machine learning model 300, the actual output 308 of the machine learning model 300 for the input object 310 is compared to the desired output value 312. One or more internal parameters 302 of the machine learning model 300 may be adjusted such that, upon running the machine learning model 300 with the new parameters, the produced output 308 will be closer to the desired output value 312. If the produced output 308 was already identical to the desired output value 312, then the internal parameters 302 of the machine learning model 300 may be adjusted to reinforce and strengthen those parameters that caused the correct output and reduce and weaken parameters that tended to move away from the correct output.

The machine learning model 300 output may be, for example, a numerical value in the case of regression or an identifier of a category in the case of classifier. A machine learning model trained to perform regression may be referred to as a regression model and a machine learning model trained to perform classification may be referred to as a classifier. The aspects of the input object that may be considered by the machine learning model 300 in making its decision may be referred to as features. After machine learning model 300 has been trained, a new, unseen input object 320 may be provided as input to the model 300. The machine learning model 300 then produces an output representing a predicted target value 304 for the new input object 320, based on its internal parameters 302 learned from training.

The machine learning model 300 may be, for example, a neural network, support vector machine (SVM), Bayesian network, logistic regression, logistic classification, decision tree, ensemble classifier, or other machine learning model. Machine learning model 300 may be supervised or unsupervised. In the unsupervised case, the machine learning model 300 may identify patterns in unstructured data 340 without training data samples 306. Unstructured data 340 is, for example, raw data upon which inference processes are desired to be performed. An unsupervised machine learning model may generate output 342 that includes data identifying structure or patterns.

The neural network may consist of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer including one or more nodes. An input layer may include the inputs to the neural network and an output layer may include the output of the neural network. A neural network may be trained and update its internal parameters, which include the weights of each neural network node, by using backpropagation.

In some embodiments, a convolutional neural network (CNN) may be used. A convolutional neural network is a type of neural network and machine learning model. A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer. In other embodiments, a recurrent neural network (RNN) may be used. A recurrent neural network is another type of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration. In still other embodiments, the recurrent neural network is a long short-term memory (LSTM) neural network. In some embodiments, the recurrent neural network is a bi-directional LSTM neural network. A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer. A gated graph sequence neural network (GGSNN) is a type of neural network that may be used in some embodiments. In a GGSNN, the input data is a graph, comprising nodes and edges between the nodes, and the neural network outputs a graph. The graph may be directed or undirected. A propagation step is performed to compute node representations for each node, where node representations may be based on features of the node. An output model maps from node representations and corresponding labels to an output for each node. The output model is defined per node and is a differentiable function that maps to an output. Further, embodiments may include neural networks of different types or the same type that are linked together into a sequential or parallel series of neural networks, where subsequent neural networks accept as input the output of one or more preceding neural networks. The combination of multiple neural networks may be trained from end-to-end using backpropagation from the last neural network through the first neural network. As stated, the machine learning model 251 may also be configured as a deep learning model. The deep learning model is a type of machine learning based on neural networks in which multiple layers of processing are used to extract progressively higher level features from data. Deep learning models are generally more adept at unsupervised learning.

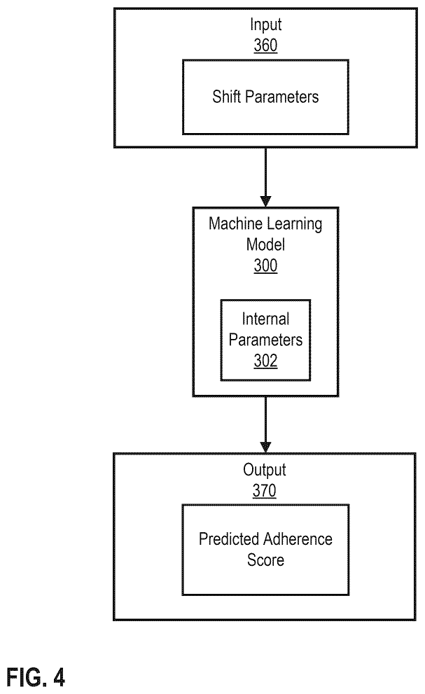

FIG. 4 illustrates use of the machine learning model 300 to perform inference on input 360. As described below, the input 302 may include shift parameters describing the shifts that are work by an agent, including the activities and duration of activities with each of the shifts. In accordance with an example embodiment, the machine learning model 300 may perform inference on the data based on its internal parameters 302 that are learned through training. The machine learning model 300 generates an output 370. In an exemplary embodiment, the output 370 may a predicted adherence score. In exemplary embodiments, the machine learning model 300 may be configured according to desirability of particular machine learning algorithms for achieving the functionality described herein. As an example, the machine learning model 300 may include one or more neural networks. In one example embodiment, the model 300 is an autoencoder machine learning model.

In other embodiments, for example, the machine learning model 300 may include a recurrent neural networks (RNNs), which are generally effective for processing sequential data, such as text, audio, or time series data. Such models are designed to remember or “store” information from previous inputs, which allows them to make use of context and dependencies between time steps. This makes them useful for tasks such as language translation, speech recognition, and time series forecasting. In some embodiments, the RNN may include long short-term memory (LSTM) networks or gated recurrent units (GRUs). Both LSTMs and GRUs are designed to address the problem of “vanishing gradients” in RNNs, which occurs when the gradients of the weights in the network become very small and the network has difficulty learning. LSTM networks are a type of RNN that use a special type of memory cell to store and output information. These memory cells are designed to remember information for long periods of time, and they do this by using a set of “gates” that control the flow of information into and out of the cell. The gates in an LSTM network are controlled by sigmoid activation functions, which output values between 0 and 1. The gates allow the network to selectively store or forget information, depending on the values of the inputs and the previous state of the cell. GRUs, on the other hand, are a simplified version of LSTMs that use a single “update gate” to control the flow of information into the memory cell, rather than the three gates used in LSTMs. This makes GRUs easier to train and faster to run than LSTMs, but they may not be as effective at storing and accessing long-term dependencies. In other embodiments, the machine learning model 520 may be configured as a sequence to sequence model comprising a first encoder model and a decoder model. The first encoder may include a RNN, or convolutional neural network (CNN), or another machine learning model capable of accepting sequence input. The decoder may include a RNN, CNN, or another machine learning model capable of generating sequence output. The sequence to sequence model may be trained on training data samples, wherein each training data sample includes a sequence of vector embeddings representing a sequence of customer journey events and a journey outcome. For example, the sequence to sequence model may be trained by inputting the input data to the first encoder model to create a first embedding vector. The first embedding vector may be input to the decoder model to create an output result of a predicted outcome. The output result may be compared to the actual outcome, and the parameters of the first encoder and the decoder may be adjusted to reduce the difference between the predicted outcome and the actual outcome. The parameters may be adjusted through backpropagation. In an embodiment, the sequence to sequence model may include a second encoder which takes in additional information related to the failed test/breaking change to create a second embedding vector. The first embedding vector may be combined with the second embedding vector as input to the decoder. For example, the first and second embedding vectors may be combined using concatenation, addition, multiplication, or another function. In another example, the features may include statistics computed on the count and order of words or characters in the data associated with particular event features, for example, words associated with a page-URL. In other embodiments, the machine learning model for outputting a predicted outcome may be an unsupervised model, such as a deep learning model. The unsupervised model is not trained and instead identifies its predictions based on identification of patterns in the data. In an embodiment, the unsupervised machine learning model may identify common features in the training dataset.

### Work Attributes Modeling to Promote Agent Adherence

The manner in which agents conduct their job functions and interact with customers determines whether a contact center is successful in its mission to deliver services in a cost effective manner. Contact centers employ a range of metrics to measure and improve the performance of agents. A primary one of these metrics is known as agent adherence, or simply adherence, and, in general, measures the extent to which an agent adheres to their work schedule and other standards associated with the performance of their work. Tracking the adherence of agents is an effective way for contact centers to increase productivity and maintain efficiency in their operations. As used herein, for contact center agents, the metric of adherence can include measures associated with schedule adherence as well as measures associated interaction adherence. Each of these will now be defined in more detail.

Schedule adherence, as used herein, measures how well contact center agents adhere to their assigned work schedule. Schedule adherence is often based on specific time intervals interacting with a customer compared to the time when the agent is failing to interact with customers during a given shift. In regard to this type of adherence, an agent may be said to be out of adherence, or out of activity, when the agent fails to conform to the particular activities scheduled within a shift. This, for example, may include showing up late to a shift, taking a break that last longer than it is scheduled to be, or ending a shift before it is scheduled to end. An out of activity measure can be calculated by comparing the desired results versus the actual results for any given agent throughout a shift or can be calculated in association with results for an given agent over a number of shifts.

In regard to interaction adherence, this measure shows how well an agent adheres to defined protocols or standards when conducting interactions with customers. As an example, for each voice interaction with a customer, a contact center may have standards requiring that certain conversation aspects are satisfied, for example, the agent to greet a customer, introduce themselves, ask for the customer's name, ask how they can help the customer, offer a particular upgrade when discussing a particular product, ask the customer if they can help the customer with anything else, and, finally, close the interaction by saying goodbye to the customer. Other interaction adherence measures may relate to the way in which the interaction is conducted in relation to certain time limits, such as completing the interaction within a particular window, for example, it may be a goal that each interaction with a customer should last longer than 2 minutes but not extend beyond 5 minutes. Further, the agent may be expected to complete after-work associated with an interaction in less than 3 minutes so that they are then available to accept another interaction in a timely manner. For each interaction, the interaction adherence for an agent can then be calculated by determining how many of these standards or measures are satisfied by the agent when handling a given interaction, which can be reflected as a percentage of the total number of applicable adherence measures. Scores associated with interaction adherence can then be calculated as average across interactions occurring within a particular timeframe. Or, adherence within a particular measure category or standard can also be calculated in relation to interactions occurring over a given timeframe. In regard to this type of adherence, an agent may be said to be out of adherence, or “out of status”, when the agent is not adequately meeting enough of the defined standards, for example, too often taking too long wrapping up an interaction or not answering an incoming phone call in a timely enough manner. An “out of status” measure can be calculated when comparing the desired results versus the actual results for any given agent throughout a shift. Such calculations can also reflect results achieved over a number of shifts.

As will be seen, the present invention provides a method for improving schedule adherence as well as interaction adherence through providing agents with individualized schedules that are found to promote improved results. A primary driver for this innovation is the realization that contact center managers and scheduling applications generally have a poor understanding as to what types of work schedules promote agent adherence. One reason for this is that the manner in which an agent's performance is affected by different types of work schedules is so varied. Yet, it is known that a primary or direct cause of agents falling out of adherence during the workday is growing feelings of fatigue and frustration over the course of the workday. The degree to which such feelings accumulate, in large part, relate to the scheduling particularities associated with an agent's workday. That is, the way in which an agent's shift plays out generally drives the degree to which feelings of fatigue and frustration develop over the course of a shift, which so negatively impact performance. In addition, the personal characteristics of an agent may amplify or diminish the feelings of fatigue or frustration. While these causal links are understood, a gap in understanding remains as to how to individualize agent work schedules so that such detrimental effects are largely avoided. As will be seen, the present invention offers ways to bridge this gap.

It will be appreciated that there are many scheduling variables—which may be referred to herein generally as “shift parameters”—that affect how a shift unfolds for an agent on a given workday. As discussed in more detail below, many of these shift parameters are reflected in the many trade-offs that are made when a contact center schedules agents. For example, over the course of a shift, the work schedule of an agent could be made to include shorter breaks that occur more frequently, or longer breaks that occur less frequently. Lunch or meal breaks could be scheduled to occur earlier in a shift or later in the shift. Or, over the course of a week, an agent could be scheduled to work fewer shifts that are longer or be scheduled to work more shifts that are each shorter. Finding the correct answer to these questions is difficult for a supervisor because the effect of such scheduling variables is so varied from agent to agent. Moreover, relying on the agent to answer these questions is also unreliable, as it has been found that agents themselves often fail to understand what the type of work schedule promotes their best performance. An agent may have an opinion as to the type of schedule they prefer, but preference does not translate in maximized performance, particularly when discussing performance in relation to adherence metrics. As a result, it is often the case that agent work schedules are created according to a “one size fits all” mindset, with supervisors scheduling agents in accordance with certain assumptions they have as to what generally works best for everyone. This approach is even more difficult when the contact center spans across geographies that have significantly different cultures for agents. In actuality, while those assumptions may work well for some of the agents, often they are less than ideal for many others. The result is that the process of agent scheduling remains highly inefficient.

One reason for this inefficiency is that conventional systems offer no solutions for determining personalized adjustments to an agent's schedule that promote adherence and maximize related performance measures. As discussed below, such adjustments may include changes to shift parameters, which may include shift start time, shift length, number of breaks, spacing of breaks, timing of meal breaks, timing of off-queue work, length of on-queue period without break, weekly shift spacing, and others. As used herein, “on-queue” refers to time during a shift when an agent is accepting and conducting interactions with customers, whereas “off-queue work” refers to other types of activities, such as training, coaching, administrative, etc., where an agent is not accepting and conducting interactions with customers but is also not on break. In terms of adherence and scheduling, agents are treated as being monolithic, with the same adherence and scheduling standards and measures being applied to an entire group of agents within contact center organizations.

In a particular contact center, for example, each agent that works the day shift may be subject to the same basic work schedule. Each agent may be asked to begin the shift at 8:00 a.m. and, for that point, be “on-queue” (i.e., accepting and conducting interactions) continuously until 10:30 a.m. At that point, each agent may receive a 10 minute break and be expected to be back on-queue by 10:40 a.m. Each agent then is expected to remain on-queue continuously until noon. At that point, the agents may receive a 30 minute meal break, with each being expected to be back on-queue by 12:30 p.m. At 1:00 p.m., the agents may be scheduled to attend a 15 minute coaching session. Each agent is then expected to be back on-queue at 1:15 p.m. Each agent then remains on-queue until 3:00 p.m., at which point each receives a 15 minute break. Each agent then returns to being on-queue by 3:15 p.m. and is expected to remain on-queue continuously until 5:00 p.m. At that point, the shift for each of the agents ends. The metrics associated with adherence measure how well each agent and the group of agents as a whole are able to comply with this schedule. In one form, adherence measures the extent to which the agents where on-queue and taking customer interactions during the time segments when the group was scheduled for that activity. As individual agents are not able to comply with this “one size fits all” schedule, adherence measures decline and the performance of the contact center is negatively impacted.

In accordance with certain embodiments, the present invention provides systems and methods for statistically modeling agent performance in relation to varying shift parameters so that agent scheduling can be individualized toward achieving improved adherence measures. Such predictive adherence programmatically adjusts shift parameters, such as start times, number of breaks, break lengths, and mealtime allotment, until a personalized schedule encourages maximized adherence for each agent. In this way, predictive adherence adjusts the mix of scheduled activities toward maximizing adherence for each agent. The adjustments to the scheduled activities may continue over time as the agents themselves may change over time.

As will be seen, several advantages flow from the present invention. First, it allows an scheduling to be programmatically tailored to individual agents, which enables the business to achieve adherence more effectively across agents in aggregate. Further, once analyzed across a large population of contact center agents, this invention may deliver an effective initial work attributes model for new agents that is based on matching agents who have similar characteristics to those agent that have been monitored by the predictive adherence system. Other advantages stem from how the present invention treats agents as individuals. That is, loyalty is promoted as agents appreciate the recognition by the contact center of their individual needs. In addition, by monitoring each individual agent's work habits and patterns with the objective of changing schedules and adherence achievements, the business is further optimized in its planning insight. This is a result of beginning to plan business around the way employees actually behave because of their personal work attributes, as opposed to planning the business around the way planners would like the employees to behave.

Attention will now turn to a simplified example in which the work performance (as defined by both schedule adherence and interaction adherence) of Agent Andy and Agent Bob are considered. It is found that Agent Andy works best in long blocks (more than 2 hours), thrives on the success of each subsequent customer call, and is productive when he shows up a few minutes early for a shift. Agent Andy, however, is not productive when staying late to wrap up work associated with calls. It is found that Agent Bob functions best within shorter blocks (1 hour). Agent Bob does not perform well with long lunch breaks and does better when having a shorter break of 10 minutes to just eat a snack so that he can then leave work a bit earlier. Such intelligence regarding the most productive work habits of Agent Andy and Bob are determined via monitoring adherence scores as shift parameters are varied. Such variation of shift parameters may happen organically (for example, a network outage may “schedule” a break for agents at an unusual time within a shift) or shift parameters may be purposefully varied or derived as a way to see what factors result in improved performance. In certain embodiments, the present system automatically adjusts agent schedules and monitors adherence results of an agent to construct a work habits model for the agent that maximizes, or at least enhances, adherence.

The contact center can then improve overall performance by scheduling the agents in ways that align with the work habits models of their respected agents. To continue the example, the system may personalize the schedules of both Agent Andy and Agent Bob to align with the work habits described above. Agent Andy may start his regular shift at 8:00 a.m., take a 15 min break at 10:30 a.m., and then a 30 minuet lunch at 12:00 p.m. Agent Andy may then resume at 12:30 p.m., take a second break at break at 3:00 p.m., and end his shift at 4:00 p.m. On the other hand, Agent Bob may begin his regular shift at 8:00 a.m., take 5 minute breaks at 9:00 a.m., 10:00 a.m., and 11:00 a.m. Agent Bob may then take just a 10 min lunch break at 12:00 p.m. Agent Bob may continue his afternoon with 5 min breaks at 1:00 p.m., 2:00 p.m., and 3:00 p.m., and end his shift at 3:30 p.m. When generic scheduling methods are used, both agents score lower in adherence. However, using personalized, automated methods of adjusting the schedule for each agent, as described herein, both agents are more effective in their work and record improved adherence results. With sophisticated statistical analysis, a personalized sequence of start times, breaks, coaching, and many other variables can be automatically adjusted to achieve greater adherence for each individual agent. This ensures the business can operate more effectively across a group of individual contact center agents, who each have their own work-sequence preferences and style.

Shift parameters, as used herein, are the parameters that describe the schedule that an agent is expected to follow during a given shift, i.e., the particular way in which a shift unfolds for an agent as they progress through their workday. Shift parameters, thus, include a shift start parameter (time that a shift is scheduled to start), shift end parameter (time that a shift is scheduled to end), shift length parameter (overall length of a shift), break parameters (types of breaks provided during a shift, e.g., how many breaks, when those breaks occur, length of breaks, when breaks for meals occur, longest stretch between breaks, length of uninterrupted on-queue period without break, breaks involving physical activity, etc.), and how the agent is scheduled to switch between different types of work over the course of the shift. This latter category—which may be referred to as a shift work-type parameter—relates to the manner in which an agent is scheduled to switch between on-queue work (i.e., work related to accepting and handling real-time interactions with customers) and other work, or off-queue work, which is work that does not involve handling real-time interactions with customers. As used herein, off-queue work may refer to other types of work activities, such as training, coaching, administrative, etc., where an agent is not accepting and conducting interactions with customers but is also not on break. Another shift parameter may include a shift work week parameter which describes the manner in which an agent's shifts are scheduled within a given work week. Shift work week parameters may include a total shifts parameter that provides a total number of shifts an agent works in a given a week and a weekly shift spacing parameter that relates to how spaced out an agent's shift are over the course of a work week. For example, the weekly shift spacing parameter may include whether an agent works double shifts, on back to back days, etc. In accordance with exemplary embodiments, as shift parameters are varied, an agent's performance in relation to one or more adherence metrics may be monitored and recorded. From there, as described more below, a work attributes model is created for the agent that can be used to predict combinations of scheduling parameters that promote high performance for a particular agent, which then may be used in scheduling the agent over future shifts.

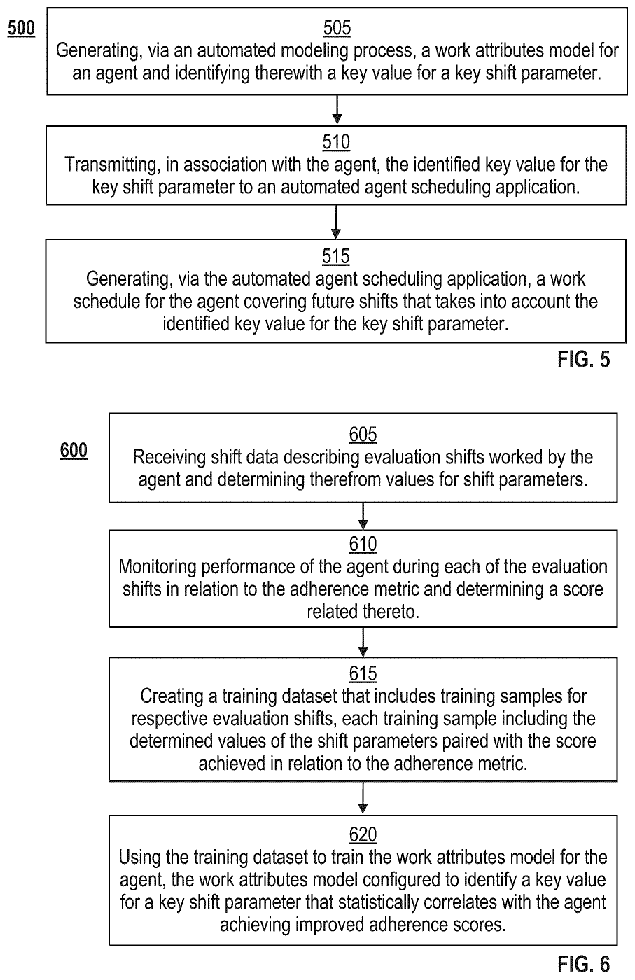

With reference now to FIG. 5, an exemplary method 500 is shown for modeling work attributes of agents to generate individualized work schedules for the agents that promote improved performance relative to an adherence metric. The method 500 begins, at step 505, by generating, via an automated modeling process, a work attributes model for an agent and identifying therewith a key value for a key shift parameter. At step 510, the method 500 continues by transmitting, in association with the agent, the identified key value for the key shift parameter to an automated agent scheduling application. At step 515, the method 500 continues by generating, via the automated agent scheduling application, a work schedule for the agent covering future shifts that takes into account the identified key value for the key shift parameter. Each of these steps will be discussed in detail below.

With reference now to FIG. 6, an exemplary method 600 is shown for an embodiment of the automated modeling process by which the work attributes model for the agent is generated. The automated modeling process of method 600 may begin at step 605 by receiving shift data describing evaluation shifts worked by the agent and determining therefrom values for shift parameters associated with each of the evaluation shifts. As used herein, “evaluation shifts” are the shifts that are used to gather and evaluate performance data for a given agent. The method 600 may continue at step 610 by monitoring performance of the agent during each of the evaluation shifts in relation to the adherence metric and determining therefrom a score for the agent associated with the adherence metric for each of the evaluation shifts. The method 600 may continue at step 615 by creating a training dataset that includes training samples for respective ones of the evaluation shifts. Each training sample may include the determined values of the shift parameters paired with the score achieved in relation to the adherence metric for one of the evaluation shifts. The method 600 may continue at step 620 by using the training dataset to train the work attributes model for the agent. The work attributes model may be configured to at least identify a key value for a key shift parameter of the shift parameters that statistically correlates with the agent achieving a better score in relation to the adherence metric.

In accordance with exemplary embodiments, the automated agent scheduling application may take into account the identified key value for the key shift parameter in several ways. While the work attributes model may identify several shift parameters and values associated with those shift parameters, the key shift parameter is the shift parameter found to most affect performance for a given agent, with the key value for the key shift parameter representing a value or range of values for the key shift parameter that works best for that agent. Of course, an automated agent scheduling application create schedules covering many agents while adequately covering anticipated workload over many future shifts. This generally results in certain compromises, whereby agents can only receive certain favorable shift attributes in certain of their shifts. Thus, one way that the automated agent scheduling application may take into account the identified key value for the key shift parameter is by mathematically weighting variables so to make it more likely that an agent would receive shifts in which the key shift parameter has the key value. In such cases, the automated agent scheduling application would mathematically weight one or more variables associated with the key value of the key shift parameter when generating the work schedule for all the agents so that the likelihood of the agent receiving future shifts that have the key value for the key shift parameter is increased. This would mean that the output of the work attributes model for the agent is used in a way that result in the agent, on average, receiving shifts having the key value for the key shift parameter more often than would have occurred without the intelligence gained from the work attributes model. In an alternative embodiment, the automated agent scheduling application takes into account the identified key value for the key shift parameter by generating the work schedule so that the agent receives one or more future shift having the key value for the key shift parameter. In another example, only those agents showing significant variation in performance would receive personalized schedules. By not personalizing shifts of agents that exhibit consistent performance, the flexibility to create highly personalized schedules for those agents that are affected by different shift parameter values is increased.

In exemplary embodiments, the evaluation shifts may be generated for a given agent so to include a range of different values for shift parameters. In this way, the affect of varying values for shift parameters can be accessed, which can then be reflected in the work attributes model for the agent. Thus, in certain embodiments, the automated modeling process may further include generating, via the automated agent scheduling application, the evaluation shifts so to include a range of different values for at least one of the shift parameters. Additionally, evaluation shifts can be monitored to detect disruptions that change values for a particular shift parameter. This, for example, may include a network failure that resulted in a prolonged break occurring at a particular time within a shift. Thus, in exemplary embodiments, the automated modeling process may further include monitoring the evaluation shifts to detect disruptions occurring therewithin, where each disruption is an unplanned modification to one of the evaluation shifts that affects a value of a shift parameter associated therewith. Then, in response to detecting a first disruption occurring within a particular evaluation shift, the automated modeling process may include determining an affected value for the shift parameter associated with the disruption and then modifying the value of the shift parameter so that the value of the first shift parameter is equal to the affected value. This allows unanticipated changes to an agent's schedule to be reflected accurately in the performance data collected for an agent. Further, it provides a way for the work attribute model for an agent to be generated on data reflecting a wider range of inputs.

In certain embodiments, the work attributes model is a machine learning model having a neural network. The work attributes model may further be a deep learning model based on a neural network having multiple hidden layers. In some preferred embodiments, the work attributes model is an autoencoder machine learning model. The works attributes model may be trained in accordance with a machine learning algorithm. As an example, when described in relation to a first training sample of the training samples in the training dataset—which is representative of how each of the training samples in the training dataset are used to train the machine learning model—the step of training the machine learning model may include: providing as input to the machine learning model the determined values of the shift parameters of the shift associated with the first training sample; generating as output of the machine learning model a predicted score for the adherence metric given the input; comparing an actual score achieved in relation to the adherence metric for the shift associated with the first training sample to the predictive score for the adherence metric and, via the comparison, determining a difference therebetween; and adjusting parameters of the machine learning model to reduce the determined difference.

In accordance with exemplary embodiments, the adherence metric may be a schedule adherence metric, interaction adherence metric, or both. As used herein, a schedule adherence metric may be a measure as to how closely an agent's actual activities conforms to scheduled work activities during a shift. For example, the schedule adherence metric may be a measure comparing time interacting with a customer to time when the agent is not interacting with customers during a given shift. As used herein, an interaction adherence metric may be a measure showing how well an agent adheres to defined protocols when conducting interactions with customers. For example, the defined protocols may include: conversation aspects, including at least a one conversation aspect regarding a standard greeting, at least one conversation aspect regarding a standard upgrade request, and at least one conversation aspect regarding a standard closing; and interaction time limits, including at least one interaction time limit regarding interaction length and one interaction time limit regarding interaction after-work length. The adherence metric may be a weighted combination of both a schedule adherence metric and an interaction adherence metric.

As used herein, shift parameters are defined as scheduling parameters describing how a given shift unfolds for an agent. In exemplary embodiments, shift parameters may include at least: a shift start parameter; a shift end parameter; a shift length parameter; and break parameters describing breaks provided during the shift. The break parameters may describe at least the following in relation to the breaks provided in the shift: how many breaks; when those breaks occur; length of breaks; when a meal break occurs. In exemplary embodiments, the shift parameters may further include parameters describing: longest uninterrupted on-queue period; breaks involving physical activity; and number of switches between on-queue work and off-queue work. In other embodiments, the shift parameters may further include shift work week parameter describing how the shifts of an agent are scheduled during a given work week. Shift work week parameters may include a total shifts parameter, which provides a total number of shifts an agent works in a given work week, and a shift spacing parameter, which relates to how spaced apart the shift of the agent are over the given work week.

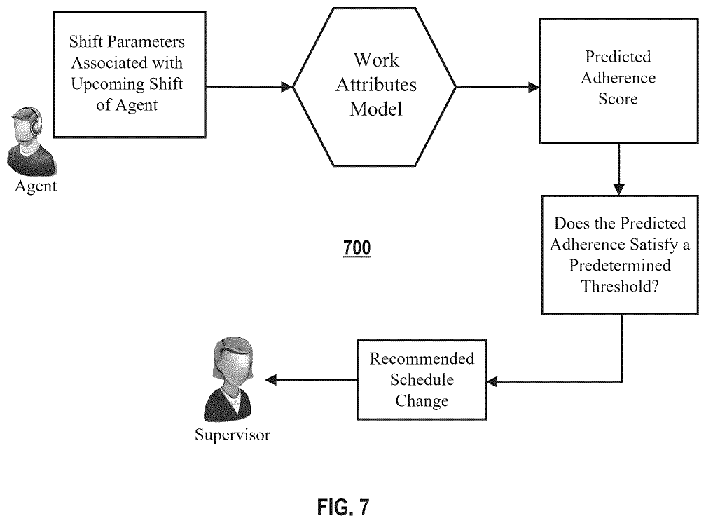

With reference now to FIG. 7, a flow diagram 700 illustrates an alternative embodiment of the present invention. Once the work attributes model for a given agent is trained, the model is then used to predict adherence scores for upcoming shifts for the agent. Specifically, the work attributes model is used as part of an automated adherence monitoring process to predict scores for the adherence metric for the agent based on shift parameters associated with upcoming shifts. For example, as shown, the adherence monitoring process first includes the step of inputting values for the shift parameters associated with an upcoming shift into the work attributes model for the agent. The model is then used to generate a predicted adherence score for the agent given the input. As a next step, the predicted adherence score is compared against a predefined minimum adherence threshold, which may be defined as an input by a supervisor. Then, based on whether the predicted adherence score fails to satisfy the minimum adherence threshold, the process may selectively trigger an automated message to a supervisor of the agent. If the predicted adherence score is unusually low (and fails to satisfy the threshold), the automated message may communicate this (i.e., the failed result) to the supervisor. In exemplary embodiments, the automated message may communicate a proactive measure designed to avoid the poor performance. For example, the automated message may communicate a work schedule modification for the agent that results in a higher predicted adherence score. Such modification may be determined by varying the key shift parameter associated with the agent to a value closer to the key value for the agent. In this way, the work attributes model, once trained, can further be used to monitor and preemptively warn a supervisor when a given agent is scheduled to work a shift having shift parameters that are particularly ill-suited for that agent. Such a situation could arise for a number of reasons, for example, it could be due to a scheduling anomaly, a particularly restrictive combination of input restraints, the agent swapping shifts with a coworker, etc. With advance warning, the supervisor would have a chance to look at alternatives that would likely improve performance for the agent while not overly affecting the performance of another agent that could also be affected by the change, thus improving overall performance. Alternatively, the supervisor would at least be put on notice that they should perhaps monitor the particular agent more closely during the identified upcoming shift.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A computer-implemented method in a contact center related to modeling work attributes of agents to generate individualized work schedules for the agents that promote improved performance relative to an adherence metric, the method comprising:
generating, via an automated modeling process, a work attributes model for an agent, wherein the automated modeling process comprises:
receiving shift data describing evaluation shifts worked by the agent and determining therefrom values for shift parameters associated with each of the evaluation shifts;
monitoring performance of the agent during each of the evaluation shifts in relation to the adherence metric and determining therefrom a score associated with the adherence metric for each of the evaluation shifts;
creating a training dataset that includes training samples for respective ones of the evaluation shifts, wherein, each training sample includes the determined values of the shift parameters paired with the score achieved in relation to the adherence metric for one of the evaluation shifts; and
using the training dataset to train the work attributes model for the agent, the work attributes model configured to at least identify a key value for a key shift parameter of the shift parameters that statistically correlates with the agent achieving a better score in relation to the adherence metric;
transmitting, in association with the agent, the identified key value for the key shift parameter to an automated agent scheduling application;
generating, via the automated agent scheduling application, a work schedule for the agent covering future shifts that takes into account the identified key value for the key shift parameter.

2. The computer-implemented method, wherein the automated agent scheduling application takes into account the identified key value for the key shift parameter by:
mathematically weighting one or more variables associated with the key value of the key shift parameter when generating the work schedule so that a likelihood of the agent receiving future shifts that have the key value for the key shift parameter is increased.

3. The computer-implemented method, wherein the automated agent scheduling application takes into account the identified key value for the key shift parameter by:
generating the work schedule so that the agent receives at least one future shift having the key value for the key shift parameter.

4. The computer-implemented method of claim 1, wherein the automated modeling process further comprises:
generating, via the automated agent scheduling application, the evaluation shifts so to include a range of different values for at least one of the shift parameters.

5. The computer-implemented method of claim 1, wherein the automated modeling process further comprises:
monitoring the evaluation shifts to detect disruptions occurring therewithin, each disruption comprising an unplanned modification to one of the evaluation shifts that affects a value of a shift parameter associated therewith;
in response to detecting a first disruption occurring within a first evaluation shift, determining an affected value for a first shift parameter associated therewith; and
modifying the value of the first shift parameter so that the value of the first shift parameter is equal to the affected value.

6. The computer-implemented method of claim 1, wherein the work attributes model comprises a machine learning model having a neural network.

7. The computer-implemented method of claim 6, wherein the work attributes model comprises an autoencoder machine learning model.

8. The computer-implemented method of claim 6, wherein, when described in relation to a first training sample of the training samples in the training dataset, which is representative of how each of the training samples in the training dataset are used to train the machine learning model, the step of training the machine learning model comprises:
providing as input to the machine learning model the determined values of the shift parameters of the shift associated with the first training sample;
generating as output of the machine learning model a predicted score for the adherence metric given the input;
comparing an actual score achieved in relation to the adherence metric for the shift associated with the first training sample to the predictive score for the adherence metric and, via the comparison, determining a difference therebetween; and
adjusting parameters of the machine learning model to reduce the determined difference.

9. The computer-implemented method of claim 1, wherein the adherence metric comprises a schedule adherence metric, the schedule adherence metric comprising a measure as to how closely an agent's actual activities conforms to scheduled work activities during a shift.

10. The computer-implemented method of claim 1, wherein the adherence metric comprises a schedule adherence metric, the schedule adherence metric comprising a measure comparing time interacting with a customer to time when the agent is not interacting with customers during a given shift.

11. The computer-implemented method of claim 1, wherein the adherence metric comprises an interaction adherence metric, the interaction adherence metric comprising a measure showing how well an agent adheres to defined protocols when conducting interactions with customers.

12. The computer-implemented method of claim 1, wherein the defined protocols comprise:
conversation aspects, including at least a one conversation aspect regarding a standard greeting, at least one conversation aspect regarding a standard upgrade request, and at least one conversation aspect regarding a standard closing; and
interaction time limits, including at least one interaction time limit regarding interaction length and one interaction time limit regarding interaction after-work length.

13. The computer-implemented method of claim 1, wherein the adherence metric comprises a weighted combination of both a schedule adherence metric and an interaction adherence metric.

14. The computer-implemented method of claim 1, wherein the shift parameters comprise scheduling parameters describing how a given shift unfolds for an agent, wherein the shift parameters include at least:
a shift start parameter;
a shift end parameter;
a shift length parameter; and
break parameters describing breaks provided during the shift.

15. The computer-implemented method of claim 1, wherein the break parameters describe at least the following in relation to the breaks provided in the shift: how many breaks; when those breaks occur; length of breaks; when a meal break occurs.

16. The computer-implemented method of claim 1, wherein the shift parameters further comprise parameters describing: longest uninterrupted on-queue period; breaks involving physical activity; number of switches between on-queue work and off-queue work.

17. The computer-implemented method of claim 1, wherein the shift parameters further comprise shift work week parameter describing how the shifts of an agent are scheduled during a given work week including at least: a total shifts parameter that provides a total number of shifts an agent works in a given work week; and a shift spacing parameter that relates to how spaced apart the shift of the agent are over the given work week.

18. The computer-implemented method of claim 1, further comprising the step of monitoring, via an adherence monitoring process, predicted scores for the adherence metric for the agent in upcoming shifts, wherein, which described in relation to a first upcoming shift of the upcoming shifts, the adherence monitoring process comprises the steps of:
inputting values for the shift parameters associated with an upcoming shift into the work attributes model for the agent and generating therewith a predicted adherence score;
comparing the predicted adherence score against an minimum adherence threshold;
based on whether the predicted adherence score fails to satisfy the minimum adherence threshold, selectively triggering an automated message to a supervisor of the agent that communicates the failed result.

19. The computer-implemented method of claim 18, wherein the automated message communicates a work schedule modification for the agent that results in a higher predicted adherence score, the work schedule modification comprising a change to the identified key value for the key shift parameter associated with the agent.

20. A system related to modeling work attributes of agents to generate individualized work schedules for the agents that promote improved performance relative to an adherence metric, the system comprising:
a processor; and
a memory storing instructions which, when executed by the processor, cause the processor to perform the steps of:
generating, via an automated modeling process, a work attributes model for an agent, wherein the automated modeling process comprises:
receiving shift data describing evaluation shifts worked by the agent and determining therefrom values for shift parameters associated with each of the evaluation shifts;
monitoring performance of the agent during each of the evaluation shifts in relation to the adherence metric and determining therefrom a score associated with the adherence metric for each of the evaluation shifts;
creating a training dataset that includes training samples for respective ones of the evaluation shifts, wherein, each training sample includes the determined values of the shift parameters paired with the score achieved in relation to the adherence metric for one of the evaluation shifts; and
using the training dataset to train the work attributes model for the agent, the work attributes model configured to at least identify a key value for a key shift parameter of the shift parameters that statistically correlates with the agent achieving a better score in relation to the adherence metric;
transmitting, in association with the agent, the identified key value for the key shift parameter to an automated agent scheduling application;
generating, via the automated agent scheduling application, a work schedule for the agent covering future shifts that takes into account the identified key value for the key shift parameter.
